(19) United States
(12) Patent Application Publication
(10) Pub. No.: US 2010/0310794 A1
(43) Pub. Date: Dec. 9, 2010

(54) Decorative Removable Ornaments With Permanently Installed Magnets

(76) Inventors: Alte B. Nordvik, Vienna, VA (US); George I. Berliner, Aliso Viejo, CA (US); Lene Marie Nordvik, Aliso Viejo, CA (US)

Correspondence Address: ERIC HANSCOM, 2141 Palomar Airport Road, Suite 320, CARLSBAD, CA, 92011, US

(21) Appl. No.: 12/794,501

(22) Filed: Jun. 4, 2010

Related U.S. Application Data
(60) Provisional application No. 61/184,835, filed on Jun. 7, 2009.

(51) Int. Cl. B60R 13/00

(52) U.S. Cl. 428/31

(57) ABSTRACT

A removable decorative and/or advertising ornament with an enclosed magnet, potentially with a protective covering, that allows the ornament to be securely yet removably attached to a metal object, such as the hood, trunk or top of a vehicle. A preferred embodiment of the invention is a foam body that contains a magnet surrounded by a mesh cloth. A barrier separates the magnet and/or mesh cloth from objects that the device is affixed to. The magnet has adequate magnetic force such that the device will remained attached to a vehicle moving at freeway speeds.

### CROSS REFERENCE TO RELATED APPLICATIONS

This application is a non-provisional of U.S. Provisional Patent Application No. 61/184,835 filed on Jun. 7, 2009, the entirety of which is hereby incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention is directed toward the general field of decorative ornaments that can be removably attached to a surface upon which the ornaments are likely to be viewed. Specifically, the invention relates to a removable decorative and/or advertising ornament with an attachment device, in a preferred embodiment, a permanently installed, built-in magnet, potentially with a protective covering, that allows the ornament to be securely yet removably attached to a metal object, such as the hood, trunk or top of a vehicle. Optionally, the ornament can be molded to provide a cavity into which the attachment device can be inserted. A preferred embodiment of the invention describes an ornament that contains a magnet, where the magnet has adequate magnetic force such that the ornament will remain attached to a vehicle moving at freeway speeds and not blow away.

The prior art describes a number of other decorative and/or advertising ornaments, but none of the previous inventions provide an ornament that can securely adhere to a moving vehicle at freeway speeds, and do so without damaging the surface upon which it is stuck. The current invention provides a solution to this problem.

There are many products that already exist which are fastened to structures for the use of advertising and decoration. Some are found in previous patents; some are generally known items for which patents were never filed. Below is a short description of some items currently being used for this purpose, specifically on automobiles including stickers, flat flexible magnet signs, hood ornaments and antenna toppers.

Adhesive stickers are by far the most common method for decorating and advertising on automobiles. While they are inexpensive to produce, they are limited in that they are only two-dimensional, and in order to be seen must be placed on surfaces that are vertically positioned. For instance, you will not notice a sticker that is placed on the roof of a car. They are also fairly permanent, and not easily removed or re-located. An additional problem with stickers is that should the adhesive begin to fail (as would be common under the driving conditions the current invention is designed to operate under), the result would be an unsightly sticker flapping in the wind, eventually disintegrating and leaving an equally unsightly patch of adhesive on the surface. Stickers also fade over time, and replacing a sticker, with its permanent adhesive backing, is a substantially more difficult than merely physically picking up an ornament and replacing it with a newer (or different) model.

Flat flexible magnetic sheets/signs are used for decorating or advertising on automobile doors, but are not designed to be used in conjunction with an ornament. These are basically sheets of thin magnetically backed vinyl that are printed on, and can be placed and peeled from a car door. These also have the limitation of needing a vertical surface to be seen, and are two-dimensional. Furthermore, because the concept of flat signs either affixed magnetically or attached more permanently through adhesive to the side of a vehicle, they do not stand out the way a 3-dimensional ornament affixed to the surface of a vehicle would have.

Decorative hood ornaments exist, but are designed to be attached through a small hole in the hood of a car, and are generally permanently secured with nuts and bolts, and can only be used in that specific opening in the hood. These require the use of tools to fasten the ornaments compared to ornaments using the magnetic force only. Allowing our magnetic ornament to be selectively removed and replaced allows a user of the invention to change the type of ornament or change its location in order to attract more attention to the advertising message conveyed by the ornament.

Antenna toppers are a type of hollow or solid ornament capable of being secured to the antenna of a vehicle and exist in all shapes. Due to the additional forces acting on the antenna with an ornament attached, the sizes of the ornaments are limited. Antenna toppers do not use magnets to hold them in place. Most toppers are designed to fit only on the very end or tip of the antenna. They have a hole, which is slipped over the end of an antenna, and is designed to create a strong enough grab or friction to stay on an antenna under normal driving conditions. More recently, some antenna toppers have been made in such a way as to stay on various places of an antenna, as opposed to just the top. These have a clip mechanism that allow placement anywhere on the antenna from top to bottom, but only on the antenna and nowhere else. Antenna toppers have over the years been very popular. They are designed specifically to fit only on antennas, and cannot be used anywhere else on the car's body. This creates a limitation from a marketing point of view, as ornaments ideally should have the design flexibility to be put anywhere on the outside of a moving vehicle to optimize visibility and marketing exposure. As with magnetic signs and other advertising means that have been used in the prior art for decades, an antenna topper is not likely to attract the attention that a three dimensional ornament placed on the hood, top, or trunk of a car will attract—basically, seeing something unexpected in an unexpected location is a superior advertising object and method.

Recent development of car antennas being built inside a car's body will soon make the external rod antennas obsolete, as these are phased out by the auto manufacturers. The antenna toppers will therefore not be functional for practical use on a car. One problem with toppers for external antennas is that they can not be used on automatically retractable antennas. If an attempt is made to use a topper on an auto-retractable antenna, either the topper will be pushed off or damage will occur to the antenna and/or ornament during retraction. Because no antennas are designed to carry additional wind generated forces to the antenna rod, the topper dimensions have to be small, making them less visible and therefore reduces their marketing value. When using larger and heavier toppers, the antennas can be bent, broken, loosened, or otherwise damaged. In addition, antenna toppers can only be used one at a time, unless additional antennas are mounted to the car. This limits the use of co-branding, as well as marketing and advertising creativity. In summary, some of the disadvantages associated with antenna toppers are listed below:
Toppers do not include the use of magnets to hold them in place.
Toppers can only be used on rod type antennas.
New built-in antennas cannot use toppers.
Toppers can only be used where the antenna is located.
Toppers cannot be used safely on retractable antennas.
Toppers size is limited in order to avoid damage to the antenna.
Toppers are small in size making them less visible and reducing their marketing value.
Co-branding is limited due to antenna strength limitation and location.

Thus there has existed a long-felt need for a three-dimensional, decorative ornament that can attract attention due to its location on a moving vehicle and have adequate means of securement such that it does not blow off during use of the vehicle. The current invention provides just such a solution by having a decorative ornament that can be magnetically attached to a vehicle where the magnet is strong enough to withstand freeway speeds of driving. The invention also has means to prevent damage to the vehicle upon which it is affixed, such that a user of the invention can use the decorative ornament for advertising or other purposes without scratching the paint or otherwise damaging the vehicle.

### SUMMARY OF THE INVENTION

This invention includes any ornament or figurine, including but not limited to those made of foam and/or rubber. The ornament can be solid, hollow, or inflatable, with a preferred embodiment being solid with a hollow portion into which the magnet can be inserted. A preferred embodiment of the invention calls for closed-cell foam (soft foam commonly used in making “stress balls” or “stress toys”) and polystyrene or Styrofoam (hard foam commonly used in making antenna toppers). These can be attached by magnetic force to most moving objects, such as automobiles, bicycles, motorcycles, boats, scooters, skateboards, trains, etc. A particularly preferred embodiment uses magnet types such as Neodymium that are much stronger than the standard refrigerator magnets. The Neodymium magnets are a member of the Rare Earth magnet family and are the most powerful permanent magnets in the world. They are also referred to as NIB (Neodymium, Iron, and Boron) magnets.

The magnets are manufactured securely into or onto the said ornament, making the magnet and ornament essentially one piece, for the purpose of promoting a company brand, logo, product, character, or team mascot/logo, or for generic sales without specific branding such as a flag, soccer ball, hula girl, etc.

The magnet size and strength used may vary depending on forces placed on the ornament to prevent tilting, sliding and releasing. The forces that may result in tilting, sliding and releasing are created by the wind, due to the speed of the object they are placed on, and by the wind that exists due to weather conditions and centrifugal forces. Larger ornaments have therefore been designed to provide a wider base and a stronger magnet to withstand forces resulting in tilting, sliding and releasing of the ornament. It should be noted that one of the major sources of damage to the surface of a vehicle could come from an ornament sliding laterally and scraping or scratching the surface.

In a preferred embodiment, these magnets have a rubber coating, or rubber barrier between the magnet and metal surface for two very important reasons: 1) to protect the surface it will be placed on from damage, and 2) to prevent the ornament from sliding along the surface when exposed to external forces. The magnets can be rubber-coated during the manufacturing process, or a separate rubber boot, cap, or cover can be placed over the magnet itself after is had been metallically plated. A separate invention is to apply a rubber material to the bottom and/or the extended base of the ornament, which will act as a barrier between the magnet and the object's surface area and prevent sliding of the ornament. This also distributes the pressure evenly to the base of the ornament so as to prevent damage to the ornament when removing it from the surface it is on. This is especially important for ornaments made of softer materials like foam.

The shape of the ornamental element is unlimited. This can include standard geometric shapes like spheres and cubes, but can also include custom shapes including sports balls, helmets, animals, movie characters, company logos, etc. However, the ornaments are intended to be small enough to not cause too much drag on a moving object, but large enough to be seen for marketing, branding, promotional, or advertising purposes. In most cases, the size will range from approximately 1″ diameter to 4″ diameter (but can be much larger, with no limit to size).

This invention has many advantages and/or improvements over existing related products. The most obvious advancement is that these three-dimensional ornaments, with the various attachment systems, can be attached by magnetic force to a moving object with high powered, permanent magnets, and can be placed in many locations on that object (or any other ferrous material) as opposed to being limited to one single location such as an antenna. This greatly increases the use of marketing creativity and is opening up a whole new arena for advertising.

These ornaments are designed to have a magnetic force that is strong enough to withstand highway speeds and wind forces, while at the same time be easily removed by hand without causing damage to the ornament or surface that it is attached to. To our knowledge, no such ornaments are currently available on the market. Our invention is therefore not simply an improvement of an existing item, but rather an entirely new and different product. This invention also exceeds the marketability and flexibility in use, and eliminates the problems associated with available products including antenna toppers used on cars. The technology behind this invention will allow for an entirely new line of products to be manufactured, creating exciting new opportunities in the fields of promotional marketing, advertising, retail sales, and licensed products.

Anticipated applications include, but are not limited to, items designed for: National Football League (NFL), National Basketball Association (NBA), Major League Baseball (MLB), National Hockey League (NHL), NASCAR, National Collegiate Athletic Association (NCAA), Movie Studios such as Disney, Warner Brothers, Fox, Universal, Sony, as well companies like Conoco/Phillips, Pepsi, Coke, Apple, Nike, and Jack in the Box.

Another advantage with the magnetic ornaments taught by this application is the increased flexibility of location placement and of using multiple ornaments simultaneously. This will greatly increase the marketability of the item due to the wide range of placement possibilities, and by using multiple ornaments at once, we are also increasing the co-branding and marketing potential.

Since we feel that antenna toppers are the closest product to our invention, it is necessary to point out the advantages of our invention of using decorative ornaments with permanent magnets when compared to antenna toppers:
Magnetic ornaments can be placed anywhere there is a magnetic attraction, compared with antenna toppers that can only be used on an antenna and nowhere else, limiting their use of placement.
Multiple magnetic ornaments can by used simultaneously, increasing branding opportunities, advertising creativity, and co-branding. Antenna toppers can only be used one at a time, unless you add additional antennas to your car. This limits the use of co-branding, as well as marketing and advertising creativity.
Magnetic ornaments have a rubber barrier, and have no damaging side effects to the surface on which they are placed. Antennas can be bent, broken, loosened, or otherwise damaged when using antenna toppers, especially when heavy, solid toppers are used.
Magnetic ornaments can be used with cars that have automatic retractable antennas. Antenna toppers cannot be used with automatic retractable antennas, as they may cause damage to the antenna and/or topper during retraction of the antenna. Therefore they are limited to use only on fixed pole antennas that do not automatically retract.
Magnetic ornaments can be larger and more visible than antenna toppers.
Magnetic ornaments can be removed easily when the conditions under which they are used could prove dangerous to the ornament or other drivers. For example, if there is a hurricane or tornado advisory in effect, most drivers will prefer not to have an object attached to their car that may fly off and hit another car. While it would be easy to remove a magnetic ornament, a user of an antenna topper may be less likely to remove it for fear of damaging it. Should a businessperson plan on leaving his or her vehicle at the Las Vegas Airport for a couple of weeks during the summer, it is likely that the 115 degree heat will damage an antenna ball or magnetic ornament left outside the car. Again, the user of the magnetic ornament is more likely to remove it and place it inside the car and out of the hot sun.
Magnetic ornaments can be placed and removed an unlimited number of times without causing damage to the ornament or the surface upon which it rests. Antenna toppers lose their integrity after removing them a few times, making them unusable or unsafe for other drivers after a period of time.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a side cross sectional view of a preferred embodiment of the invention that includes a magnet and barrier.

FIG. 2 is a side view of the magnet and barrier shown in FIG. 1.

FIG. 3 is a top view of the magnet and barrier shown in FIG. 1.

FIG. 4 is a perspective view of a car with various embodiments of the current invention affixed thereto.

### DETAILED DESCRIPTION OF THE INVENTION

Since the patentability of this invention is based in a major part on the superiority of its adhesion capabilities, a review of the field testing that went into it is useful in demonstrating the significance of its improvements over the prior art. During prototype field tests, ornaments were placed on 14 locations on an automobile, positioned strategically on the front edge of the hood and the front edge of the roof, where the highest wind resistance is created when a vehicle is moving.

The ornaments were numbered from 1 to 7 and had the NIB magnets as shown in Table 1.

TABLE 1
Ornament numbering and type of magnets

| Numbers on Ornament | Magnet |
|---|---|
| 1. Baseball w/caps | NIB Rubber #2 |
| 2. Jack in the Box | NIB Rubber #2 |
| 3. 76 | NIB Rubber #2 |
| 4. Baseball helmet | NIB #1 with black electro tape |
| 5. Texas helmet | NIB #1 with black electro tape |
| 6. Orca whale | NIB #1 with black electro tape |
| 7. Baseball | NIB Rubber #2 with black electro tape |

All prototypes withstood vehicle speeds of 100 miles per hour (100 mph), which is equivalent to roughly 160 kilometers per hour (160 km/h), with an outside wind speed measured at a maximum of 118.6 mph (191 km/h), using a Kestrel 1000 Pocket Wind Meter (anemometer). All ornaments tested had a ⅞″ diameter Neodymium magnet attached to the ornaments. Testing was done under two types of conditions. First, wind was generated with a “leaf blower” type of machine and measured with an anemometer. Second, a vehicle upon which ornaments had been affixed was driven under controlled conditions at a variety of speeds at a secure testing location.

By comparison, when standard refrigerator magnets were attached to same ornaments, and placed on the same locations of the vehicle, said ornaments fell off at a speeds ranging from 37 mph (60 km/h) to 62 mph (100 km/h), confirming our suspicion that weak standard refrigerator magnets would not be safe to use under normal driving conditions, especially at highway speeds under windy circumstances.

Two tests were done with ornaments placed on a car driving at various speeds. In test 1 all ornaments were placed on the hood in the area where the wind forces acting on the ornaments were expected to be highest. The ornaments were marked from 1 to 7 and placed by increasing number starting with number 1 from left to right seen from driver's location.

The results from test 1 are listed in Table 2. The wind speed was recorded in kilometers per hour when the car's speed was increased in increments of 10 km/h from 70 km/h up to 160 km/h. The wind speeds in mph were later recalculated from km/h for ease of reference giving a total of 8 readings. Test 1 was carried out when driving on a north-westerly track with the wind coming from a southerly direction. During test 1, none of the ornaments moved or lost grab during the test and the magnetic force was strong enough to keep all ornaments in their position at speeds up to 160 km/h. The wind speed acting on the ornaments at various car speeds are shown in Table 2 and the highest recorded wind speed was 137 km/h at a car speed of 130 km/h.

TABLE 2
Wind speed acting on the ornaments
on the hood at various car speeds

| Reading (#) | Car Speed (km/h/mph)* | Wind Speed (km/h/mph) |
|---|---|---|
| 1 | 70/43.47 | no data |
| 2 | 80/49.68 | 70/43.47 |
| 3 | 90/55.89 | 81/50.30 |
| 4 | 100/62.1 | 93/57.75 |
| 5 | 110/68.31 | 98/60.86 |
| 6 | 120/74.52 | 121/75.14 |
| 7 | 130/80.73 | 137/85.08 |
| 8 | 160/99.36 | no data |

In test 2, all ornaments were placed on the roof in the area where the wind forces acting on the ornaments were expected to be highest. The ornaments were placed in the same order as in test 1 with increasing numbers from left to right seen from driver's location.

The wind speed acting on the ornaments at various car speeds are shown in Table 3 and the highest recorded wind speed was 191 km/h at a car speed of 160 km/h.

TABLE 3
Wind speed acting on the ornaments
on the roof at various car speeds

| Reading (#) | Car Speed (km/h/mph)* | Wind Speed (km/h/mph) |
|---|---|---|
| 1 | 70/43.47 | No data |
| 2 | 80/49.68 | 84/52.16 |
| 3 | 90/55.89 | 93/57.75 |
| 4 | 100/62.1 | 105/65.21 |
| 5 | 110/68.31 | 114/70.79 |
| 6 | 120/74.52 | 128/79.49 |
| 7 | 130/80.73 | 140/86.80 |
| 8 | 160/100 | 191/118.6 |

Additional tests were performed to determine the force required to tilt or slide ornaments of different sizes and magnet strengths, and was conducted with the ornaments from the speed test marked number 2 and number 7 in addition to ornament number 7A and 7B with smaller ⅝″ diameter magnets. The magnet on ornament 7A was a standard refrigerator magnet while 7B was a stronger ⅝″ NIB type.

The ornament was placed on an iron structure. The weight was placed at the center of the ornament approximately 3 cm from the surface of the iron structure. A small container that could be filled with water was used as weight and water was added until the ornament tilted. The container with water was then put on a scale and the load determined. Results from the tilt and slide tests are presented in Table 4.

TABLE 4
Results from the tilt and slide tests

| Ornament | | Tilt Weight | Slide Weight | Magnet only |
|---|---|---|---|---|
| (#) | Magnet Type | (kg/lbs) | (kg/lbs) | (kg/lbs) |
| 2 | NIB #2 - 1″ | 1.5/3.3 | 1.5/3.3 | 3.08/6.78 |
| 7 | NIB #2 - 1″ | 1.09/2.4 | 1.09/2.4 | — |
| 7A | Refrigerator ⅝″ | 0.03/0.07 | 0.03/0.07 | 0.075 |
| 7B | NIB ⅝″ | 0.55/1.21 | 0.55/1.21 | — |

Under controlled wind conditions, wind speed testing was done with a Toro 150 mph blower to simulate wind speeds and associated forces of wind acting on a moving object. Winds were measured at a maximum of 230 km/h (142 mph), and all of the magnetic prototypes used in the car speed tests remained secured to the metal plate, even under these extreme wind forces.

Similar testing applied to ornament 7A using the standard ⅝″×⅛″ thick refrigerator magnet released from the metal plate at speeds of 60 km/h (35 mph). A similar test was done with ornament 7A with a larger ⅞″ standard refrigerator magnet that released at a speed of 100 km/h (62.1 mph). This shows that these standard refrigerator magnets do not have sufficient strength to be used for ornaments placed on vehicles under normal driving conditions.

The following are characteristics of the neodymium magnets used in testing.

NIB Magnet #1 (RE22CS-N):
Nickel Plated Neodymium Ring Magnet
Dimensions: ⅞″ od×0.127″ id×0.240″ id×⅛″ thick
Tolerances: ±0.002″×±0.002″×±0.002″×±0.002″
Material: NdFeB, Grade N42
Plating/Coating: Ni—Cu—Ni (Nickel)
Magnetization Direction: Axial (Poles on Flat Ends)
Weight: 0.319 oz. (9.05 g)
Pull Force: 42.35 lbs
Surface Field: 2885 Gauss
Brmax: 13,200 Gauss
BHmax: 42 MGOe

The foregoing are ⅞″ diameter×⅛″ thick countersunk ring magnets sized to accept a #5 countersunk screw. The RE22CS-N is magnetized with the north pole on the countersink side.

NIB Magnet #2:
Rubber Coated Neodymium Ring Magnet
Dimensions: 1″ od× 5/16″ id×¼″ thick
Tolerances: ±0.002″×±0.002″×±0.002″
Material: NdFeB, Grade N42
Plating/Coating: Black Rubber Coated
Magnetization Direction: Axial (Poles on Flat Ends)
Weight: 0.768 oz. (21.8 g)
Pull Force: 33.40 lbs
Surface Field: 3445 Gauss
Brmax: 13,200 Gauss
BHmax: 42 MGOe

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

FIG. 1 is a side cross sectional view of a preferred embodiment of the invention that includes a magnet and barrier. The decorative removable ornament according to the current invention includes a foam body 10 that contains a magnet 20. The magnet is preferably enclosed within a mesh cloth 21 to help retain the magnet within the main body 10. A barrier 30 prevents the magnet 20 and mesh bag 21 from coming in direct contact with external objects, such as the surface of a vehicle.

A multistep process is involved to manufacture the decorative removable ornament according to the current invention. First, a mold is created. The mold defines the shape of the decorative removable ornament. Shapes include without limitation spheres, hats, helmets, mascots, cubes, cars, heads, and pyramids.

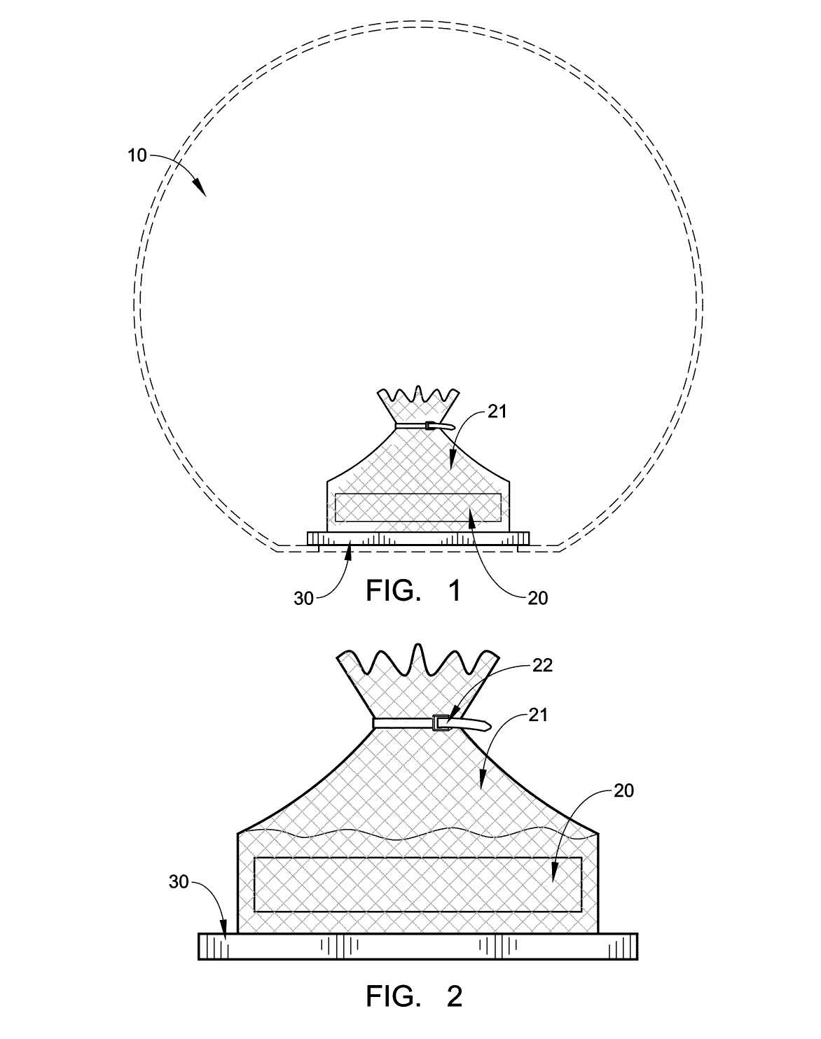

A magnet must also be prepared for placement into the mold. To prepare the magnet, a magnet, preferably a neodymium magnet, is enclosed within a mesh cloth. As shown in FIG. 2, the mesh cloth 21 completely surrounds the magnet 20. A wire, clip, zip tie, or other comparable means are used to secure the mesh cloth 21 around the magnet 20. The mesh cloth can be manufactured from a variety of materials, but is preferably a portion of porous fabric.

Once prepared, the mesh cloth that houses the magnet is placed into the mold and then foam is injected into the mold to create the foam body. The magnet is positioned in such a way that it will be proximate to an external surface of the decorative removable ornament. The mesh cloth adheres to the foam as it cures thereby acting as an anchor that secures the magnet within the foam body. The foam is allowed to cure and is then is removed from the mold.

Artwork, if any, is applied to the external surface of the foam body. Elements of artwork include printed material, often in color, that is applied to the external surface of the foam body. For example, a foam body in the shape of a baseball hat can have a baseball team's logo affixed thereto.

Finally, a barrier is placed over the magnet and mesh cloth. The barrier, preferably made from rubber or foam, prevents the magnet and/or mesh cloth from damaging a surface to which the decorative removable ornament is affixed thereto. The barrier is affixed to the mesh cloth and/or magnet by means of an adhesive, such as glue. For example, the barrier prevents the magnet and/or mesh cloth from scratching the surface of a vehicle should the decorative removable ornament slide across a surface of the vehicle, such as when a user slides the decorative removable ornament in an attempt to remove it from the vehicle. The barrier should be flush with the external surface of the foam body, such that there is a flat surface of the decorative removable ornament (bottom surface). While there is a mesh cloth and barrier between the magnet and external surface of the decorative removable ornament, the magnet is nonetheless considered proximate to an external surface of the decorative removable ornament.

In place of a barrier, the foam body can enclose the magnet. While the magnet is close to the surface of the foam body, a portion of the foam body resides between the magnet and the external surface of the decorative removable ornament. Alternatively, the magnet itself can be rubber coated, thereby removing the need for a separate barrier that insulates the magnet from another surface.

FIG. 2 is a side view of the magnet and barrier shown in FIG. 1. The magnet 20 is contained within a mesh cloth 21. A zip tie 22 is shown to secure the edges of the mesh cloth 21 together thereby enclosing the magnet 20 within the mesh cloth 21. A barrier 30 is affixed to the bottom of the mesh bag 21 to prevent damage to any surface it is affixed to.

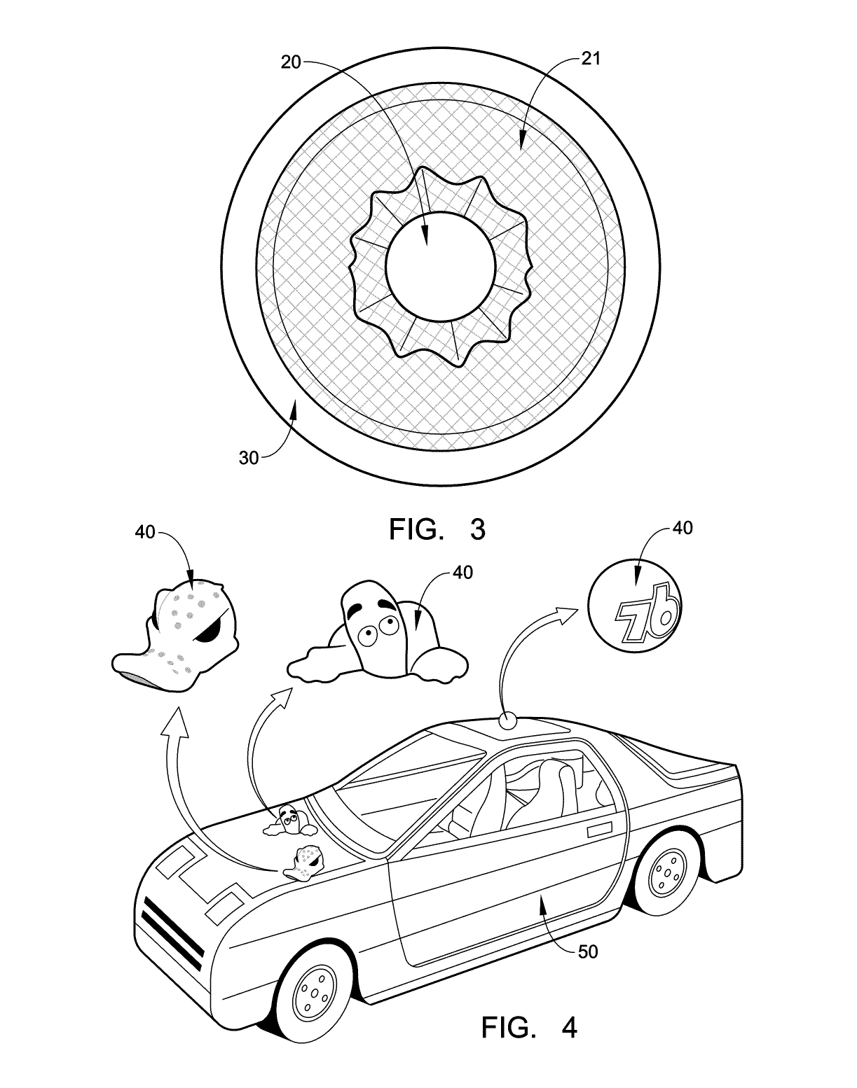

FIG. 3 is a top view of the magnet and barrier shown in FIG. 1. The mesh cloth 21 is secured around a magnet 20. Even when secured around the magnet 20, the mesh cloth may nonetheless have an opening. This opening is of no consequence since it is directed towards the middle of the foam body. Opposite of the opening, if any, is located a barrier 30.

FIG. 4 is a perspective view of a car with various embodiments of the current invention affixed thereto. Use of the current invention is straightforward. A user takes the decorative removable ornament 40 and places the magnetic side on a ferrous metallic object, such as an outside surface of a vehicle 50. To remove the decorative removable ornament, the user applies a force greater than that of the magnet in a direction away from the surface to which the decorative removable ornament was attached.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A device comprising
a foam body, a magnet, a mesh cloth, and a barrier,
where the mesh cloth encloses the magnet, where the mesh cloth and magnet are secured within the foam body, where the barrier is affixed to the mesh cloth, and where the barrier is flush with an external surface of the foam body.

2. The device of claim 1, wherein the magnet is a neodymium magnet.

3. The device of claim 1, wherein the barrier comprises rubber.

4. The device of claim 1, wherein the barrier comprises foam.

5. The device of claim 1, further comprising a wire, where the wire secures the mesh cloth around the magnet.

6. The device of claim 1, further comprising a zip tie, where the zip tie secures the mesh cloth around the magnet.

7. The device of claim 1, wherein the barrier is affixed to the mesh cloth by means of an adhesive.

8. The device of claim 1, wherein the foam body has one or more elements of artwork affixed thereto.

9. A device comprising
a foam body and a magnet, where the magnet is secured within the foam body, where the magnet is proximate to an external surface of the device.

10. The device of claim 9, further comprising a mesh cloth, where the magnet is enclosed within the mesh cloth.

11. The device of claim 9, further comprising a barrier, where the barrier forms a part of the external surface of the device.

12. The device of claim 11, wherein the magnet is adjacent to the barrier.

13. The device of claim 11, further comprising a mesh cloth, where the magnet is enclosed within the mesh cloth, where the mesh cloth is adjacent to the barrier.

14. The device of claim 13, wherein the barrier is adhered to the mesh cloth.

15. The device of claim 11, wherein the barrier comprises rubber.

16. The device of claim 9, wherein the foam body has one or more elements of artwork affixed thereto.

17. The device of claim 9, wherein the magnet is a neodymium magnet.

18. A device comprising
a foam body, a neodymium magnet, a mesh cloth, and a barrier,
where the mesh cloth encloses the magnet, where the mesh cloth and magnet are secured within the foam body, where the barrier is adhered to the mesh cloth, where the barrier is flush with an external surface of the foam body, where the foam body has one or more elements of artwork affixed thereto.

19. The device of claim 18, further comprising a wire, where the wire secures the mesh cloth around the magnet.

20. The device of claim 18, wherein the neodymium magnet has a surface field of 2885 Gauss or more.
